(19) United States
(12) Patent Application Publication
(10) Pub. No.: US 2003/0194188 A1
(43) Pub. Date: Oct. 16, 2003

(54) Adapter

(76) Inventors: Masato Shiino, Tokyo (JP); Hideki Miyazaki, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/188,407

(22) Filed: Jun. 28, 2002

Related U.S. Application Data
(63) Continuation-in-part of application No. 10/122,468, filed on Apr. 11, 2002, now abandoned.

(51) Int. Cl. G02B 6/36

(52) U.S. Cl. 385/53

(57) ABSTRACT

An adapter includes a conductive plate made of an electrical conductive material and disposed between first and second receptacles for individually accommodating first and second optical connector plugs. Optical fibers accommodated in the connector plugs are optically connected to one another in an opening formed in the conductive plate that shields electromagnetic waves which would be radiated to the outside through the optical connector plugs. The conductive plate is grounded and excellent in electromagnetic shielding effect.

### CROSS-REFERENCES TO RELATED APPLICATION

This is a continuation-in-part application of Ser. No. 10/122,468 filed on Apr. 11, 2002.

### BACKGOURNG OF THE INVENTION

1. Field of the Invention

The present invention relates to an adapter through which optical connectors are connected, and more particularly, to an adapter for shielding electromagnetic waves which would be radiated from an optical module to the outside through the optical connectors.

2. Related Art

A conventional optical module, e.g., a semiconductor laser module including a semiconductor laser which is small in optical power output, radiates electromagnetic waves that are negligible in intensity. With the advance of optical communication technologies, recent optical modules are required to provide high power, so that large currents flow in electronic circuits contained therein, thus causing a higher intensity of electromagnetic waves to radiate to the outside that may exert electromagnetic influences on peripheral electronic circuits.

In an optical module provided with a receptacle at an end for connection with an optical connector, therefore, a shielding measure is sometimes taken for eliminating such electromagnetic influences.

On the other hand, for an adapter mounted on a wiring board or the like for connection of optical connectors, electromagnetic shielding measure that is simple and inexpensive has not been realized as yet.

### SUMMARY OF THE INVENTION

It is an object of the present invention to provide an adapter providing simple and inexpensive shielding measures to eliminate electromagnetic influences.

According to one aspect of the present invention, there is provided an adapter for connecting first and second optical connectors, which comprises first and second receptacles for accommodating at least parts of the first and second optical connectors, respectively, and an electromagnetic shielding member disposed between the first and second receptacles and having grounding portion made of a conductive material and an opening for permitting the first and second optical connectors to be optically connected to each other.

With this adapter, electromagnetic waves which would be otherwise radiated from an optical module, connected to the optical connector accommodated in the first or second receptacle, to the outside through the optical connectors are shielded by means of the electromagnetic shielding member grounded and disposed between the first and second receptacles, thereby eliminating electromagnetic influences with ease and at low costs.

According to another aspect of the present invention, there is provided an adapter for connecting first and second optical connectors, which comprises first and second receptacles for accommodating at least parts of the first and second optical connectors, respectively, and a housing made of a conductive material and attached to at least one of the first and second receptacles.

With the adapter, it is possible to simply and inexpensively eliminate influences caused by electromagnetic waves, which would be otherwise radiated from an optical module connected to the optical connector accommodated in the first or second receptacle to the outside through the optical connectors, by means of the housing mounted to at least one of the first and second receptacles.

The above and other objects, features and advantages of the present invention will be clearer from the following detailed description based on the accompanying drawings.

### BRIEF DESCRIPTION OF THE DRAWINGS

FIG. 1 is an exploded perspective view showing an adapter according to a first embodiment of the present invention, together with part of an optical connector;

FIG. 2 is a perspective view showing a panel to which the adapter shown in FIG. 1 is mounted;

FIG. 3 is an exploded perspective view showing a first modification of the adapter shown in FIG. 1;

FIG. 4 is an exploded perspective view showing a second modification of the adapter shown in FIG. 1;

FIG. 5A is a view showing clearances between the panel shown in FIG. 2 and the adapter according to the second modification that are formed when the adapter is mounted to the panel;

FIG. 5B is a view showing an electromagnetic shielding effect achieved by an adapter according to a second embodiment of the present invention to shield electromagnetic waves which would be otherwise radiated through the clearances;

FIG. 6 is an exploded perspective view of the adapter shown in FIG. 5B;

FIG. 7 is a perspective view of the adapter shown in FIG. 6;

FIG. 8 is an exploded perspective view showing a first modification of the adapter shown in FIGS. 5A, 6 and 7;

FIG. 9 is a perspective view of the adapter shown in FIG. 8:

FIG. 10 is an exploded perspective view showing a second modification of the adapter shown in FIGS. 5B, 6 and 7;

FIG. 11 is a perspective view of the adapter shown in FIG. 10;

FIG. 12 is an exploded perspective view of an adapter according to a third embodiment of the present invention;

FIG. 13 is a perspective view showing the adapter shown in FIG. 12 in a state where a housing is mounted on one of the receptacles; and

FIG. 14 is a perspective view showing the adapter shown in FIG. 12 in a state where housings are mounted to both the receptacles.

### DETAILED DESCRIPTION

In the following, an adapter according to a first embodiment of the present invention will be described.

The adapter is adapted to connect first and second optical connectors to each other. Each connector is constituted by a multifiber connector such as an MPO (Multifiber Push-On) connector.

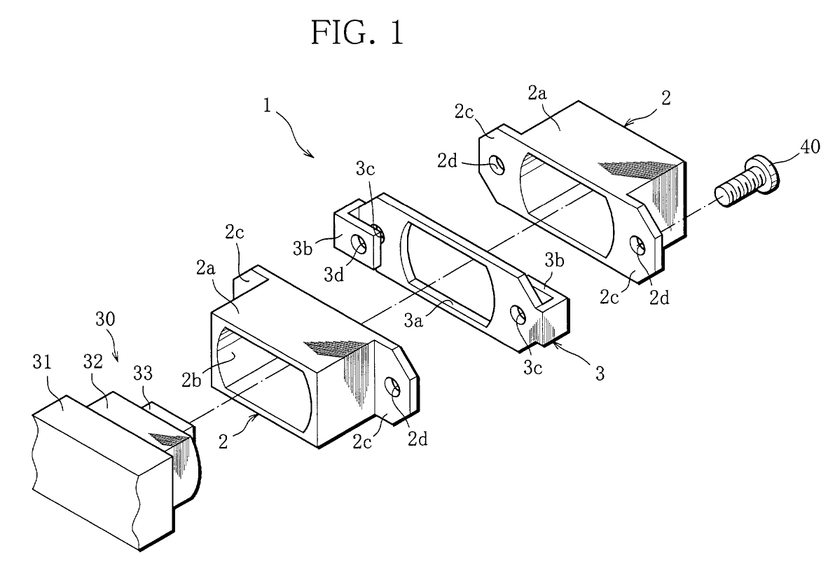

As shown in FIG. 1, the first optical connector 30 is comprised of a connector body 31 and a plug 32 integral therewith. The plug 32 has a ferrule 33 accommodating therein optical fibers (not shown). The second optical connector (not shown) is constructed in the same manner as the first optical connector 30. The optical fibers accommodated in the first optical connector 30 are connected to optical fibers extending from, e.g., an optical module (not shown), and the optical fibers accommodated in the second optical connector are connected to optical fibers extending from, e.g., an optical component (not shown).

The adapter 1 comprises first and second receptacles 2 for individually accommodating therein at least parts, e.g., plugs, of the first and second optical connectors, and a conductive plate 3 disposed between the first and second receptacles 2. The conductive plate 3 serves as an electromagnetic shielding member for shielding electromagnetic waves which would be otherwise radiated from the optical module to the outside through the first and second optical connectors.

Each of the first and second receptacles 2 is molded of a synthetic resin such as polybutyleneterephthalate (PBT), polyphenylenesulphide (PPS), and comprises a prismatic receptacle body 2a and two flanges 2c extending outwardly from the receptacle body 2a in the widthwise direction, respectively. The receptacle 2 is formed with an opening 2b extending therethrough, so that the optical connector plug is permitted to pass through the opening 2b.

The adapter 1 is adapted to be mounted to an electrically conductive mounting member that is provided in a wiring board, such as a panel 20 shown in FIG. 2. In the example shown in FIG. 2, the adapter 1 is mounted to an arbitrary one of mounting holes 20a formed in the panel 20 and fixed to the panel 20 by means of screws (one of which is shown by reference numeral 40 in FIG. 1) made of an electrically conductive metal that threadedly engage with screw holes 2d formed in the flanges 2c of the receptacles 2 and screw holes 20b formed in the panel 20. The panel 20 is electrically grounded, and the adapter 1 is grounded through the panel 20.

The conductive plate 3 is constituted by a conductive resin which comprises, for example, carbon powder, or conductive metal powder such as copper, aluminum, silver uniformly mixed in a synthetic resin such as polybutyleneterephthalate (PBT), polyphenylenesulphide (PPS), or a conductive metal such as copper, aluminum, silver.

As shown in FIG. 1, the conductive plate 3 is formed at its central portion with an opening 3a, so that the plugs of the first and second optical connectors may face to each other in the opening 3a and optical fibers accommodated in these optical connectors may be optically coupled to one another.

The conductive plate 3 is provided at its opposite ends with first and second grounding pieces 3b that cooperate with the metal screws and at least the opposite ends of the conductive plate 3 to constitute a grounding portion. The first grounding piece 3b has a first portion thereof extending from one end of the conductive plate 3 toward the first receptacle 2 in the thickness direction of the conductive plate, and a second portion thereof extending inwardly from the distal end of the first portion in the widthwise direction of the conductive plate. The first grounding piece 3b is configured to permit the flange 2c of the first receptacle 2 to be fitted in between the second portion of the first grounding piece and the conductive plate 3. The second grounding piece 3b is constructed in the same manner as the first grounding piece 3b, but differs therefrom in that its first portion extends toward the second receptacle in the thickness direction of the conductive plate, i.e., in the direction opposite to the direction in which the first portion of the first receptacle extends. The second grounding piece 3b is configured to permit the flange 2c of the second receptacle 2 to be fitted in between the conductive plate 3 and the second portion of the second grounding piece that extends inwardly from the distal end of the first portion in the widthwise direction of the conductive plate. In FIG. 1, reference numeral 3c denotes screw holes formed in the opposite end portions of the conductive plate 3, and reference numeral 3d denotes screw holes formed in the first and second grounding pieces 3c in alignment with the screw holes 3c.

To assemble the adapter 1 constructed as described above, a corresponding one of the flanges 2c of the first receptacle 2 is inserted into between the first grounding piece 3b and the conductive plate 3 and one of the flanges 2c of the second receptacle 2 is inserted into between the second grounding piece 3b and the conductive plate 3, whereby end faces 2e of the first and second receptacle 2 are disposed to face opposite faces of the conductive plate 3, respectively. Next, the first and second receptacles 2 are fused or bonded to the conductive plate 3, in a state that the screw hole 2d of the first receptacle 2 is aligned with the screw hole 3d of the first grounding piece 3b and one of the screw holes 3c of the conductive plate 3, whereas the screw hole 2d of the second receptacle 2 is aligned with the screw hole 3d of the second grounding piece 2b and another screw hole 3c of the conductive plate 3, whereby the first and second receptacles 2 are unified with the conductive plate 3 to thereby obtain the adapter 1.

As described previously, the adapter 1 is mounted in the mounding hole 20a formed in the panel 20 that is provided in a wiring board. The mounting hole 20a is formed into a rectangular shape similar to the cross sectional shape of the receptacle body 2a of the adapter 1 and has an opening area that is slightly broader than the cross sectional area of the receptacle body 2a, so that the receptacle body 2a may be inserted into the mounting hole 20a with clearances. At both sides of the mounting hole 20a, the panel 20 is formed with screw holes 20b so as to be aligned with the screw holes 2d, 3c and 3d formed in the adapter 1.

In mounting the adapter 1 to the panel 20, the receptacle body 2a of one of the first and second receptacles, e.g., the first receptacle is inserted into the mounting hole 20a of the panel 20 and the flanges 2c of the first receptacle are brought into contact with the panel 20. In this condition, a screw (not shown) is tightened after it is engaged with the screw hole 2d of a corresponding one of the flanges of the second receptacle, the screw hole 3c of the conductive plate 3, the screw hole 2d of a corresponding one of the flanges of the first receptacle, and one of the screw holes 20b of the panel. Another screw (not shown) is tightened after it is engaged with the screw hole 2d of another flange of the second receptacle, the screw holes 3c and 3d of the conductive plate 3, the screw hole 2d of another flange of the second receptacle, and another screw hole 20b of the panel 20.

After the adapter 1 is mounted to the panel 20, the first optical connector 30 is mounted to the first receptacle 2 and the second optical connector (not shown) is mounted to the second receptacle 2, whereby optical fibers accommodated in the ferrules of the first and second optical connectors are disposed to face with one another and optically connected. Further, the optical fibers accommodated in the first and second optical connectors are connected to optical fibers individually extending from an optical module and an optical component (none of which is shown), whereby the optical module is optically connected to the optical component through the optical connectors.

During the operation of the optical module, electromagnetic waves can be radiated from the optical module to the outside through the optical connectors, especially when the optical module is of high output type. In this regard, the adapter 1 of this embodiment is provided with the conductive plate 3 disposed between the first and second optical connectors to shield electromagnetic waves radiated from the optical module to thereby prevent the electromagnetic waves from being radiated to the outside. In addition, when the adapter 1 mounted to the panel 20 as previously described, the first and second grounding pieces 3b of the conductive plate 3 are electrically connected with the panel 20, so that the conductive plate 3 is grounded through the panel to have improved electromagnetic shielding effect. Moreover, the adapter 1 has a simplified configuration such that the conductive plate 3 is disposed between the receptacles.

Accordingly, even if an optical connector connected to an optical module of a high output type is accommodated in one of the receptacles, the conductive plate 3 positively shields electromagnetic waves radiated from the optical module, thereby simply and inexpensively eliminating influences of the electromagnetic waves on peripheral electronic circuits.

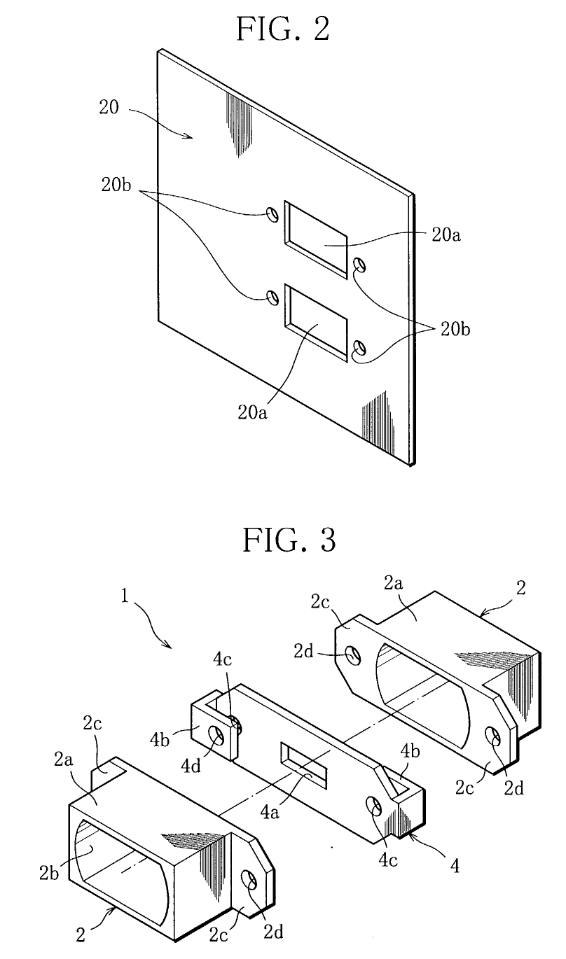

Next, an adapter according to a first modification of the first embodiment will be described with reference to FIG. 3.

The adapter 1 according to the first modification comprises a conductor plate 4 in place of the conductive plate 3 shown in FIG. 1 that is disposed between the first and second receptacles 2. The conductive plate 4 is formed with an opening 4a instead of the opening 3a shown in FIG. 1. The opening 4a is slightly larger than the outer size of the ferrule (shown by reference numeral 33 in FIG. 1) of the optical connector, e.g., the MPO connector. That is, the opening 4a is smaller than the opening 3a.

In other respects, the adapter 1 according to the first modification are the same as the first embodiment. In FIG. 3, reference numeral 4b denotes the first and second grounding pieces respectively corresponding to the grounding pieces 3b shown in FIG. 1, and reference numerals 4c and 4d denote screw holes respectively corresponding to the screw holes 3c and 3d shown in FIG. 1.

The effects and advantages attained by the adapter 1 according to the first modification are the same as those of the first embodiment. Namely, the adapter 1 is mounted to, e.g., the panel 20 shown in FIG. 2, and the conductive plate 4 of the adapter 1 is grounded through the panel 20. Subsequently, the plugs of the first and second optical connectors (not shown) are individually inserted into the first and second receptacles of the adapter, so that optical fibers accommodated in respective ferrules of the first and second optical connectors are disposed to face one another in the opening 4a of the conductive plate 4 and optically connected to one another. During the operation of an optical module connected to, e.g., the first optical connector, the conductive plate 4 shields electromagnetic waves which would be otherwise radiated from the optical module to the outside through the optical connectors. This makes it possible to provide an adapter having an electromagnetic shielding function and permitted to be mounted to a wiring board or the like simply and inexpensively.

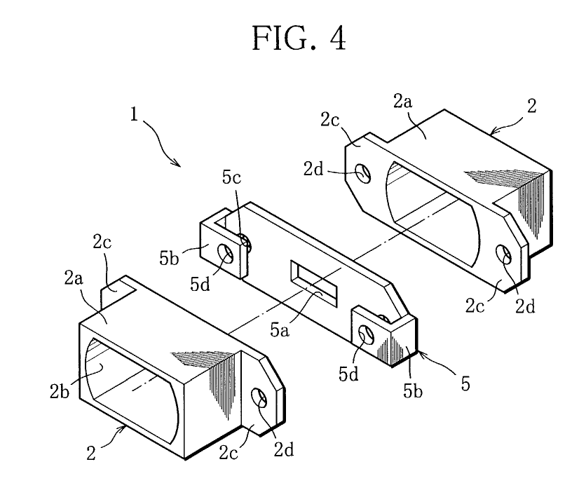

In the following, with reference to FIG. 4, an adapter according to a second modification of the first embodiment will be described.

In the second modification, a conductive plate 5 is disposed between the first and second receptacles 2 instead of the conductive plate 3 shown in FIG. 1. The first and second grounding pieces 3b shown in FIG. 1 are disposed on the first and second receptacle sides of the conductive plate 3, respectively. Contrary to this, both the first and second grounding pieces 5b of the second modifications are disposed on the first receptacle side of the conductive plate 5. That is, the first and second grounding pieces 5b are comprised of first portions thereof individually extending from the opposite ends of the conductive plate 5 toward the first receptacle in the thickness direction of the conductive plate and second portions thereof extending inwardly from the distal ends of the first portions in the widthwise direction of the conductive plate.

In other respects, the adapter 1 of the second modification is constructed in the same manner as the first modification. In FIG. 4, reference numeral 5a denotes an opening corresponding to the opening 4a shown in FIG. 3, and reference numerals 5c and 5d denote screw holes respectively corresponding to the screw holes 4c and 4d shown in FIG. 4.

To assemble the adapter 1 of the second modification, the two flanges 2c of the first receptacle of the adapter 1 are inserted between the first grounding piece 5b and the conductive plate 5 and between the second grounding piece and the conductive plate, respectively, and the second receptacle 2 is brought in contact with the face of the conductive plate on the side remote from the grounding pieces. Next, the first and second receptacles 2 and the conductive plate 5 are bonded or the like so that they are formed into one piece, with the screw hole 2d of each receptacle to be aligned with the screw holes 5c and 5d of the conductive plate 5. Then, the adapter 1 is mounted to the panel 20.

The effects and advantages attained by the adapter 1 of the second modification are the same as those attained by the first modification, and hence explanations thereof are omitted herein.

Next, an adapter according to a second embodiment of this invention will be explained.

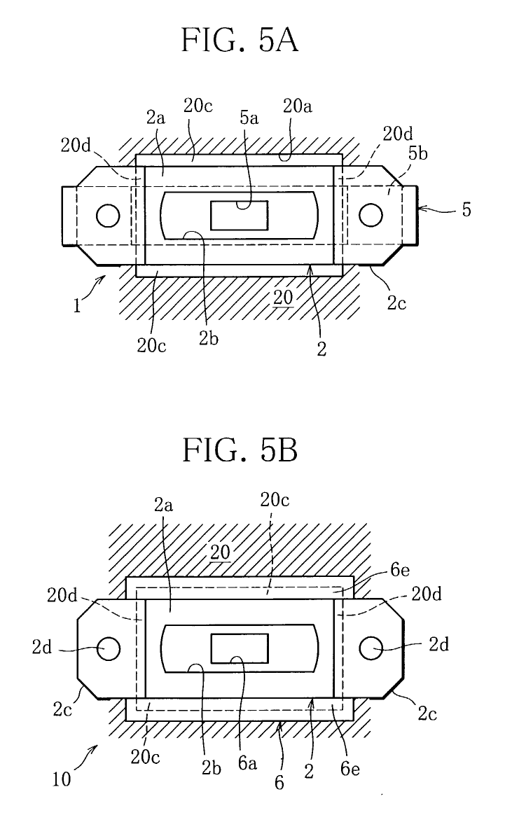

As mentioned previously, the adapter according to the first embodiment or its first or second modification is fixed by means of screws, in a condition that, e.g., the first receptacle body 2a is inserted into the mounting hole 20a formed in the panel 20. FIG. 5A shows by way of example the adapter 1 according to the second modification of the first embodiment in a state where it is mounted to the mounding hole 20a, where the rectangular mounting hole 20a which is considerably large in size than the receptacle body 2a of the adapter is formed in the panel 20, and thus clearances 20c are present between the peripheral edge of the mounting hole 20a and the long sides of the receptacle body 2a and clearances 20d are present between the peripheral edge of the mounting hole 20a and the short sides of the receptacle body 2a. This causes a fear that electromagnetic waves are radiated to the outside through the clearances 20c and 20d.

The adapter of the second embodiment are different from the first embodiment mainly in that it positively shields electromagnetic waves which would be radiated to the outside through the clearances between the receptacle body and the peripheral edges of the mounting hole 20a and in that the first and second grounding pieces 3c shown in FIG. 1 are eliminated from the conductive plate, but are the same as the first embodiment in other respects.

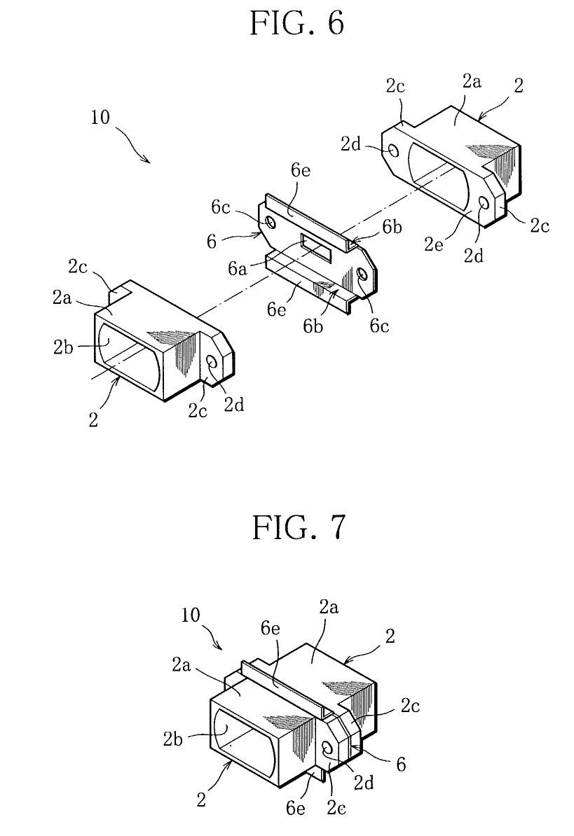

As shown in FIGS. 5B and 6, the adapter 10 of the second embodiment has first and second receptacles 2 for individually accommodating first and second optical connectors (not shown), and a conductive plate (electromagnetic shielding member) 6 corresponding to the conductive plate 3 shown in FIG. 1. The conductive plate 6 is comprised of a conductive plate body which is substantially the same in shape as an end face 2e of the receptacle 2, first and second extension portions 6b individually extending from upper and lower edges (long-side edges) of the conductive plate body toward the first receptacle (upward and downward) in the thickness direction of the conductive plate, and third and fourth extension portions (first and second flange pieces) 6e individually extending outwardly from the distal edges of the first and second extension portions in the height direction of the conductive plate. The first flange piece 6e cooperates with the first extension portion to form a first grounding piece, and the second flange piece 6e cooperates with the second extension portion to form a second grounding piece. The first and second grounding pieces cooperate with at least the opposite end portions of the conductive plate body to form a grounding portion. The conductive plate body is formed with an opening portion 6b and screw holes 6c respectively corresponding to the opening portion 4a and the screw holes 4c shown in FIG. 3.

The length of projection of the first and second grounding pieces 6b toward the first receptacle is set to a value substantially the same as the thickness of the flanges 2c of the first receptacle, so that the first and second flange pieces 6e may abut against the panel 20 when the first receptacle 2 is in contact with the panel 20, with the first receptacle inserted into the mounting hole 20a of the panel 20.

The first and second flange pieces 6e have their width greater than the long side length of the mounting hole 20a of the panel 20, and have their height that makes the distance between the upper edge of the first flange piece 6e and the lower edge of the second flange piece 6e greater than the short side length of the mounting hole 20a. Since the conductive plate 6 is provided with the flange pieces 6e of such width and height, the first and second flange pieces 6e abut the panel 20 when the adapter 10 is mounted to the panel 20, with the first receptacle inserted into the mounting hole 20a. As a result, the flange pieces 6e close the clearances 20c and 20d between the first receptacle body 2a and the peripheral edges of the mounting hole 20a (see, FIG. 5B), thereby shielding electromagnetic waves which would be radiated to the outside through the clearances.

In assembling the adapter 10, the conductive plate 6 is retained between the end faces 2e of the first and second receptacles 2 and the screw holes 2d of the flanges 2c of the receptacles are aligned with the screw holes of the conductive plate 6, in a condition that the end portion of the first receptacle 2 on the flange 2c side is inserted between the first and second extension portions 6b of the conductive plate 6, whereby the first and second receptacle 2 and the conductive plate 6 of the adapter 1 are formed into one piece, as shown in FIG. 7.

In mounting the adapter 10 shown in FIG. 7 to the panel 20, the receptacle body 2a of the first receptacle 2 is inserted into the mounting hole 20a of the panel 20, and then screws (not shown) are tightened after they are engaged with the screw holes 2d of the second receptacle, the screw holes 6c of the conductive plate 6 and the screw holes 2d of the first receptacle, thereby fixing the adapter 10 to the panel 20. Under the fixed condition, the flanges 2c of the first receptacle of the adapter 10 and the first and second flange pieces 6e of the conductive plate 6 are in contact with the panel 20, so that the conductive plate 6 is electrically connected with the panel 20 and grounded through the panel, and the first and second flange pieces 6e of the conductive plate 6 close the clearances 20c and 20d between the first receptacle body 2a and the peripheral edge of the mounting hole 20a.

Subsequently, the first and second optical connectors are individually accommodated in the first and second receptacles of the adapter 10, and as a result optical fibers accommodated in ferrules of these connectors are optically connected to one another through the opening 6a formed in the conductive plate 6. During the operation of an optical module connected to, e.g., the first optical connector, the conductive plate 6 shields electromagnetic waves which would be radiated from the optical module to the outside through the optical connectors, and especially, the first and second flange pieces 6e of the conductive plate 6 shield the electromagnetic radiation though the clearances 20c and 20d between the first receptacle body 2a of the adapter 10 and the peripheral edges of the mounting hole 20a of the panel 20.

Next, an adapter according to a first modification of the second embodiment will be explained.

The adapter 10 of the first modification is different from the second embodiment in the construction of the first and second grounding pieces of the conductive plate, but are the same in other respects.

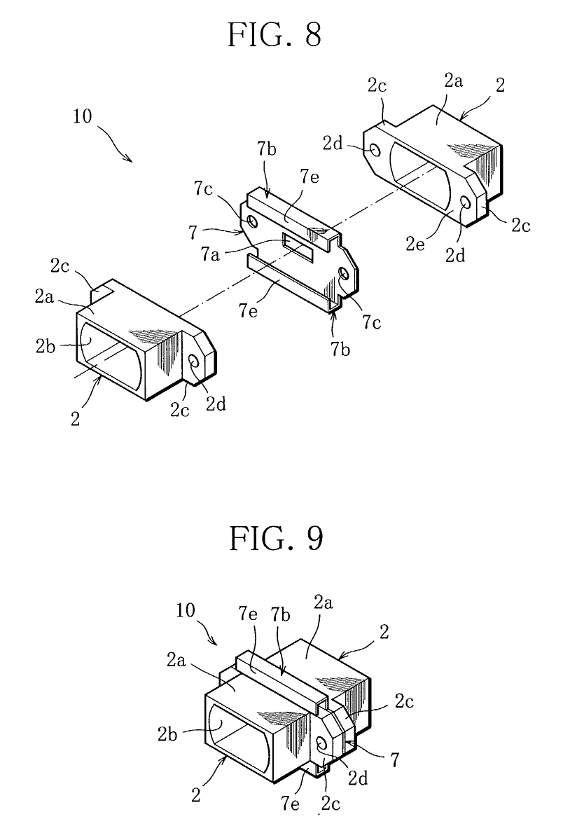

As shown in FIGS. 8 and 9, the adapter 10 of the first modification is provided with a conductive plate 7 which is disposed between the first and second receptacles instead of the conductive plate 6 shown in FIG. 6.

The conductive plate 7 is comprised of a conductive plate body, first and second extension portions individually extending outwardly (upward and downward) from upper and lower edges of the conductive plate body in the height direction of the conductive plate, third and fourth extension portions 7b individually extending from upper and lower edges of the first and second extension portions toward the first receptacle in the widthwise direction of the conductive plate, and fifth and sixth extension portions (first and second flange pieces) 7e individually extending inwardly (downward and upward) from distal edges of the third and fourth extension portions 7b in the height direction of the conductive plate. The first flange piece 7e cooperates with the first and third extension portions to form a first grounding piece, whereas the second flange piece 7e cooperates with the second and fourth extension portions to form a second grounding piece. The first and second grounding pieces cooperate with at least the opposite end portions of the conductive plate body to form a grounding portion.

The width and height of the first and second extension portions are the same as those of the first and second flange pieces 7e and set to the same dimensions as those of the flange pieces 6e shown in FIG. 6. The second and fourth extension portions have their width and projection length toward the first receptacle which are the same as those of the first and second extension portions 6b shown in FIG. 6.

The conductive plate body is formed with an opening 7a and screw holes 7c individually corresponding to the opening 6a and the screw holes 6c shown in FIG. 6.

The adapter 10 of the first modification is assembled and mounted to the panel 20 in the same manner as in the second embodiment, and accordingly explanations are omitted herein.

When the adapter 10 of the first modification is fixed to the panel 20, the flanges 2c of the first receptacle 2 of the adapter 10 and the first and second flange pieces 7e of the conductive plate 7 are in contact with the panel 20, the conductive plate 7 is grounded through the panel 20, and the first and second flange pieces 7e of the conductive plate 7 close the clearances 20c, 20d between the first receptacle body 2a and the peripheral edges of the mounting hole 20a. During the operation of an optical module, the conductive plate 7 shields electromagnetic radiation to the outside and especially the flange pieces 7e shield electromagnetic radiation through the clearances 20c and 20d.

Next, an adapter according to a second modification of the second embodiment will be explained.

The adapter of the second modification is different from the second embodiment in construction of the first and second grounding pieces of the conductive plate, but are the same in other respects.

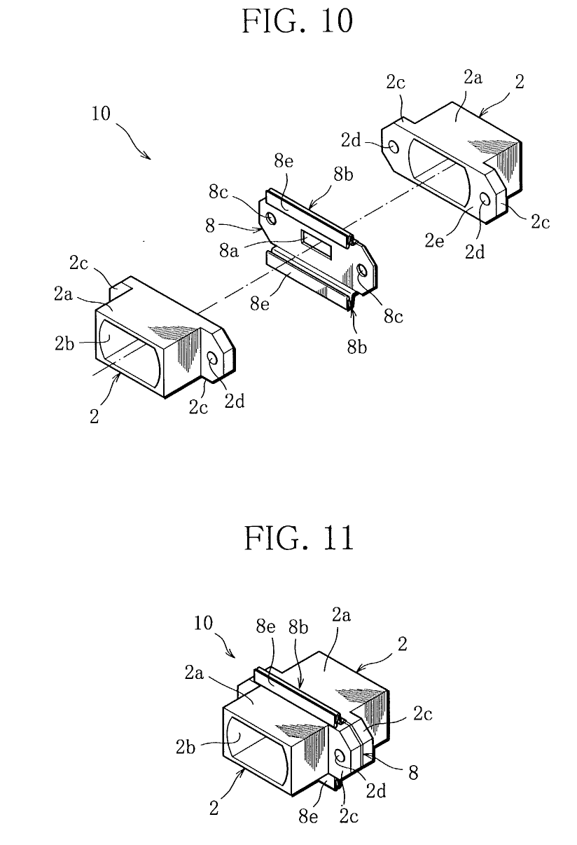

As shown in FIGS. 10 and 11, the adapter 10 of the second modification is provided with a conductive plate 8 which is disposed between the first and second receptacles instead of the conductive plate 6 shown in FIG. 6.

The conductive plate 8 is comprised of a conductive plate body, first and second extension portions individually extending from upper and lower edges of the conductive plate body toward the first receptacle in the thickness direction of the conductive plate, third and fourth extension portions 8b individually extending outwardly from distal edges of the first and second extension portions in the height direction of the conductive plate and then extending inwardly in the height direction so that they are bent in an accordion fashion, and fifth and sixth extension portions (first and second flange pieces) 8e individually extending outwardly from distal edges of the third and fourth extension portions in the height direction of the conductive plate. The first flange piece 8e cooperates with the first and third extension potion to form a first grounding piece, whereas the second flange piece 8e cooperates with the second and fourth extension portions to form a second grounding piece. The first and second grounding pieces cooperate with at least the opposite end portions of the conductive plate body to form a grounding portion.

The first and second extension portions have their width which is equal to that of the first and second extension portions 6b shown in FIG. 6, and on the other hand have their projection length toward the first receptacle which is shorter than that of the extension portions 6b. As mentioned previously, the second and fourth extension portions are bent, and thus have their projection length toward the first receptacle. The sum of this projection length and that of the first and second extension portion is substantially equal to the projection length of the extension portions 6b shown in FIG. 6. The first and second flange pieces 8e have their width and height that are equal to those of the first and second flange pieces 6e shown in FIG. 6.

The adapter 10 according to the second modification is assembled and mounted to the panel 20 in the same manner as in the first modification, and explanations thereof will be omitted. To be noted, in the adapter 10 of the second modification, the conductive plate 8 is provided with the second and fourth extension portions that are bent in an accordion fashion, and hence the first and second flange pieces 8e of the conductive plate 8 are in urged contact with the panel 20 by means of the spring function of the second and fourth extension portions, so that the electromagnetic shielding function of the first and second flange pieces 8e is much improved.

Next, an adapter according to a third embodiment of the present invention will be explained.

As compared to the first and second embodiments where the conductive plate for electromagnetic shielding is disposed between the first and second receptacles, the adapter of the third embodiment is different in that a housing for electromagnetic shielding is mounted to the first and/or second receptacle.

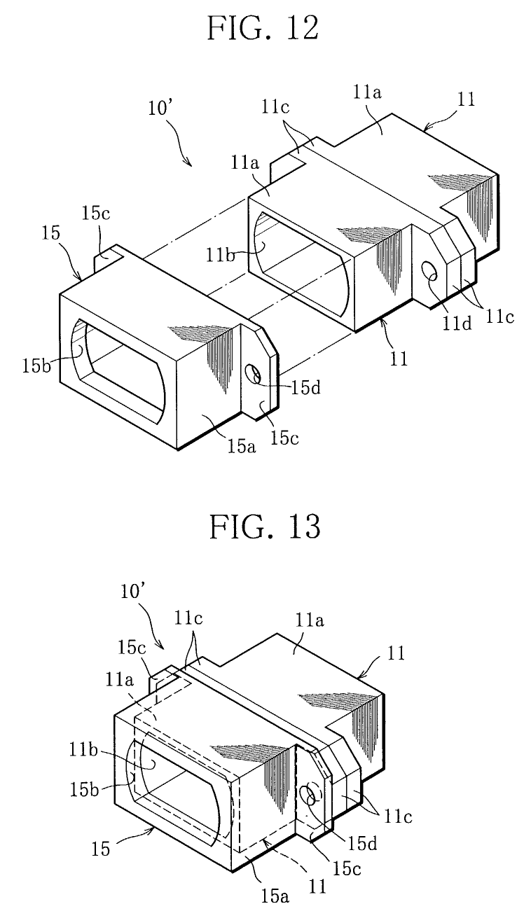

As shown in FIG. 12, the adapter 10′ according to the third embodiment is comprised of first and second receptacles 11 which are fused or bonded with use of adhesive so as to be formed into one piece, and the housing 15 is mounted to at least one of the receptacles 11. Respective plugs of first and second optical connectors (not shown) are accommodated in the first and second receptacles 11 of the adapter 10′ and optical fibers accommodated in these connector plugs are optically connected with one another.

The receptacles 11 each comprises a prismatic body 11a which is formed with an opening 11b for permitting a plug of a multifiber connector such as an MPO (Multifiber Push-On) connector to pass therethrough and formed with flanges 11c extending outwardly in the widthwise direction of the adapter. Each flange 11c is formed with a screw hole 11d for fixation to a panel (shown by reference numeral 20 in FIG. 2) of a wiring board, which is made of a conductive metal and grounded beforehand.

The housing 15 is constituted by a conductive material that is substantially the same kind as that of the conductive plate 3 shown in FIG. 1, and comprises a prismatic housing body 15a defining therein an accommodation space which is complementary in shape to the receptacle 11. The housing body 15a is formed with an opening 15b which permits an optical connector to pass therethrough and formed with flanges 15c extending outwardly from the housing body 15a in the widthwise direction. Screw holes 15d are formed in the housing body 15a. The electromagnetic shielding effect is lowered if the opening 15b is too large, whereas if the opening 15b is too small, an optical connector is prevented from passing therethrough.

The housing 15 can be mounted to the first or second receptacle 11 after the first and second receptacles are fixed to a panel, as shown in FIG. 13 in which the illustration of the panel (shown by reference numeral 20 in FIG. 2) is omitted. In such a case, screws (not shown) are tightened after they are threadedly engaged with the screw holes 11d of the flanges 11c of the first and second receptacles, thereby fixing the first and second receptacles to the panel. Subsequently, the housing 15 of the adapter 10′ is mounted to the first receptacle 11 so as to surround the same, and the flanges 15c of the housing 15 are in contact with another face of the panel. Under these conditions, the housing is fixed to the panel by means of screws (not shown) which are threadedly engaged with the screw holes 15d formed in the flanges 15c, and the housing is grounded through the panel. If the panel is thin in thickness, the screw holes 15d of the housing 15 and the screw holes 11d of the receptacle are formed at different positions to avoid interference between the screws for receptacle fixation and the screws for housing fixation.

Even if a multifiber connector connected to a high power optical module is accommodated in the receptacle 11 on which the housing 15 is mounted or in another receptacle, the housing 15 shields strong electromagnetic waves which would be radiated from the optical module to the outside through the connectors. In this manner, the adapter 10′ can eliminate electromagnetic influences simply and inexpensively.

Alternatively, the housing 15 of the adapter 10′ may be mounted to a panel of a wiring board together with the first and second receptacles 11. In such a case, the housing 15 is mounted on one of the receptacles 11, and another receptacle 11 is inserted into a mounting hole formed in the panel and abutted at its flanges 11c against the panel. Under these conditions, the housing 15 and the first and second receptacles 11 are fixed to the panel by means of screws threadedly engaged with the screw holes 11d, 15d of the flanges 11c, 15c.

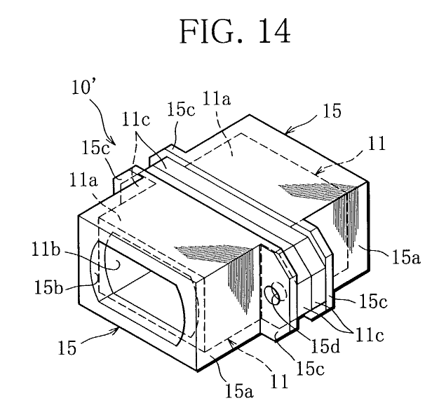

In order to enhance the electromagnetic shielding effect, first and second housings 15 are mounted to both the receptacles 11, respectively, as shown in FIG. 14. In such a case, the first and second housings 15 are individually mounted to the first and second receptacles 11 so as to surround the same, and, the second receptacle 11 and the second housing 15 are inserted into the mounting hole of the panel and the flanges 15c of the second housing 15 are in contact with the panel. Under these conditions, the first and second housings 15 and the first and second receptacles 11 are fixed to the panel by means of screws threadedly engaged with the screw holes 15d of the first housing 15, the screw holes 11d of the first and second receptacles, and the screw holes 15d of the second housing 15.

The present invention is not limited to the first through third embodiments and their modifications, and may be modified variously.

For instance, although the foregoing embodiments have been described for an adapter for an MPO connector, the present invention is applicable to an adapter for a mulitifiber connector other than the MPO connector and to an adapter for a single-fiber connector.

In mounting an adapter to a panel, conductive mounting means other than metal screws may be employed. For instance, an adapter and a panel may be formed with bolt holes (not shown) instead of screw holes and the adapter and the panel may be tightened between the heads of bolts passing through these bolt holes and nuts threadedly engaged therewith.

The two receptacles may be formed into one piece in advance, instead of the two receptacles being fused or bonded into one piece as in the third embodiment.

Furthermore, the features of the first through third embodiments and their modifications may be combined variously. For instance, the housing of the third embodiment for electromagnetic shielding may be mounted to at least one of the first and second receptacles of the first embodiment which are coupled to each other with a conductive plate for electromagnetic shielding interposed therebetween.

What is claimed is:

1. An adapter for connecting first and second optical connectors, comprising:
first and second receptacles for accommodating at least parts of the first and second optical connectors, respectively; and
an electromagnetic shielding member disposed between the first and second receptacles and having grounding portion made of a conductive material and an opening for permitting the first and second optical connectors to be optically connected to each other.

2. The adapter according to claim 1, wherein said grounding portion is connected to a conductive mounting member disposed outside the adapter.

3. The adapter according to claim 2, wherein said adapter is mounted to the conductive mounting member with use of a conductive mounting means, with said first or second receptacle inserted into a mounting hole formed in the conductive mounting member, and said grounding portion is connected to the conductive mounting member through the conductive mounting means.

4. The adapter according to claim 3, wherein said grounding portion has a flange pieces that are in contact with the conductive mounting member to shield electromagnetic waves which would be radiated through a clearance between the adapter and the mounting hole.

5. An adapter for connecting first and second optical connectors, comprising:
first and second receptacles for accommodating at least parts of the first and second optical connectors, respectively; and
a housing made of a conductive material and attached to at least one of the first and second receptacles.

6. The adapter according to claim 5, wherein said housing is connected to a conductive mounting member disposed outside the adapter.

7. The adapter according to claim 6, wherein said adapter is mounted to the conductive mounting member with use of a conductive mounting means, with said first or second receptacle inserted into a mounting hole formed in the conductive mounting member, and said housing is connected to the conductive mounting member through the conductive mounting means.
